(19) United States
(12) Patent Application Publication
(10) Pub. No.: US 2007/0001665 A1
(43) Pub. Date: Jan. 4, 2007

(54) Stabalize position by electromagnetic field sensing

(76) Inventor: Leonard Reiffel, Chicago, IL (US)

Correspondence Address: William J Hallihan;Hallihan Intellectual Property Law, Suite 2080, 125 South Wacker Drive, Chicago, IL, 60606, US

(21) Appl. No.: 10/555,949

(22) PCT Filed: May 6, 2004
(86) PCT No.: PCT/US04/14122

§ 371 Date: Nov. 7, 2005

(30) Foreign Application Priority Data
May 6, 2003 (US) 468366

(51) Int. Cl. G01B 7/14; G01B 7/30; H01F 5/00

(52) U.S. Cl. 324/207.15

(57) ABSTRACT

A position control product uses a signal from an electomagnetic field sensor 11 to cause a positioning sub-system 31 to keep at least a first target coordinate 121 in a preplanned relationship with at least a first reference coordinate 111, the product being especially useful in radiation oncology where it is important to keep a target volume 71 in a body 81 in a preplanned relationship with a radiation beam, the product being useful also in other cases where the position of a reference coordinate relative to a target coordinate can not be determined by other means.

This application claims priority of U.S. provisional application 60/468,366 filed 06 May 2003, which is incorporated herein by reference.

In one form, a position control product uses a signal from an electromagnetic field sensor 11 to cause a positioning sub-system 31 to keep at least a first target coordinate 121 in a preplanned relationship with at least a first reference coordinate 111.

The product is especially useful in radiation oncology, or other applications, where it is important to keep a target volume 71 in a body 81 in a preplanned relationship with a radiation beam. The product can be useful where the position of a reference coordinate relative to a target coordinate can not be easily, or accurately, determined by other means.

While using a magnetic compass to steer a ship, and measuring the magnetic field produced by a charged particle beam in order to steer the particle beam are both old art, neither old art can be adapted to provide linear counteracting motion in order to keep a target coordinate within at least a millimeter of a fixed preplanned position relative to a fixed reference coordinate. In one form, the product provides counteracting linear motion in order to keep a target coordinate within less than a centimeter, such as within 9 mm, 7 mm, 5 mm, 3 mm, 2 mm, 1 mm or even within 0.5 mm, of a fixed preplanned position relative to a fixed reference coordinate.

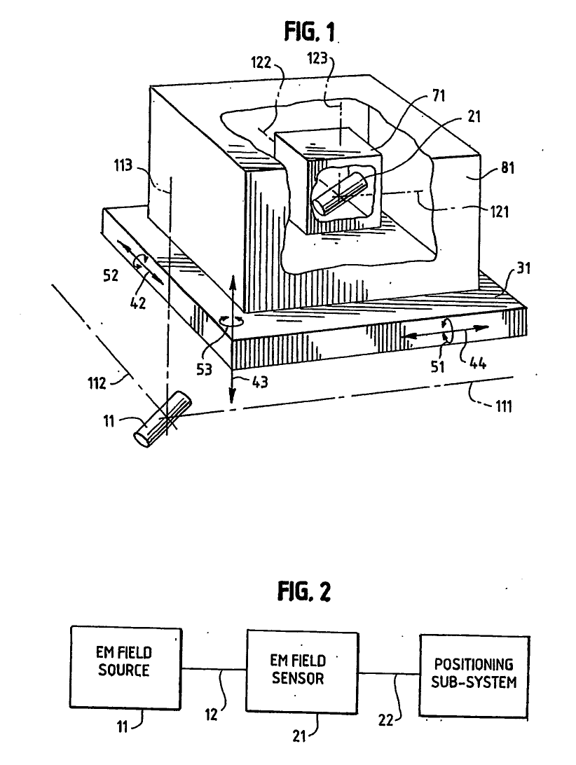

Elements of one form of the product are shown schematically in FIG. 1.

Connections among elements of the product of FIG. 1 are shown schematically in FIG. 2.

In one form of the position control product, a positioning controller is used with a positioning sub-system 31, the positioning sub-system in use can move a target volume 71 in order to keep the target volume in a preplanned position. To do this the positioning sub-system can move the body 81, can move the target volume in the body, and can move combinations of these.

The positioning controller comprises an electromagnetic field 12 represented schematically by an electromagnetic field source 11, an electromagnetic field sensor represented schematically by 21, and a signal represented schematically by 22.

A change in the field measured by the sensor represents motion of at least one of a triad of orthogonal target coordinates: 121, 122, 123 relative to at least one of a triad of orthogonal reference coordinates: 111, 112, 113. The sensor outputs the signal 22 which represents the motion. The signal causes the positioning subsystem 31 to cause counteracting motion to keep the at least one target coordinate in the preplanned relationship with the at least one reference coordinate.

The target coordinates can have a known volume relationship with the target volume. The reference coordinates can have a known device relationship with a device acting on the target volume. Either, and both, of these relationships can be static, can be dynamic, and can be combinations of these. Either, and both, relationships can be known a priori, can be measured while the product is in use, and can be known by combinations of these. In a radiation oncology case the target volume can be a cancerous tumor and the “device” can be a radiation beam.

In one form of the invention the sensor 21 has a known sensor relationship with target coordinates and the field 12 has a known field relationship with the reference coordinates as depicted schematically by a filed source 11 in FIG. 1. In this form the sensor can be embedded in a body as depicted schematically in FIG. 1.

The sensor and the source of the field can be interchanged. Thus, in another form of the invention the field (now represented schematically in FIG. 1 by a field source 21) has a known relationship with the target coordinates and the sensor (now represented schematically in FIG. 1 by 11) has a known relationship with the reference coordinates. In this form a field source can be embedded in the body.

The product could use combinations of these forms.

In either of these forms the known sensor relationship can be static, can be dynamic, and can be combinations of these. Also, the known field relationship can be static, can be dynamic, and can be combinations of these. Either, and both, the sensor relationship and the field relationship can be a priori known, can be measured while the product is in use, and can be combinations of these.

In a form of the product the sensor can detect liner motions of a sensor triad of orthogonal linear motions and can detect a sensor triad of orthogonal rotations of the target coordinates relative to the reference coordinates. In this form the signal can cause the positioning sub-system 31 to cause a positioning triad of orthogonal counteracting linear motions—for example 41, 42, 43—and to cause a positioning triad of orthogonal counteracting rotations—for example 51, 52, 53—in order to maintain the preplanned relationship between the target and reference coordinates.

A form of the product could also detect strains of the target coordinates relative to the reference coordinates, and the signal can cause the positioning sub-system to cause counteracting strains to maintain the preplanned relationship between the target and reference coordinates.

The field can be caused by a magnet. The magnet can be a permanent magnet, can be an electromagnet, and can be combinations of these. The field could be the magnetic field of the earth. The field could be a field caused by sources normally present in the environment where the product is used.

The field can have several component sources.

The field source, and alternatively at least one component source of the field, can comprise electromagnetic radiation caused by a transmitter.

The field, and alternatively at least one component source of the field, can be modulated by mechanical means, by electrical means, and by combinations of these. This would aid distinguishing the field from any unavailing fields detected by the sensor.

The field can be configured in order to provide a maximal spatial change in the field.

The preplanned relationship can be a static relationship, can be a dynamic relationship, and can be combinations of these.

The sensor can have components. Sensor components can be configured in order to have components detect respective properties of the field.

In a form of the invention where the sensor is embedded in a body the signal can be carried out of the body by wired means, by wireless means, and by combinations of these. If power is needed by a sensor embedded in a body, then the power can be provided an power source embedded with the sensor, provided by wired means, provided by wireless means, and provided by combinations of these. If power is needed by a field source embedded in a body, then the power can be provided an power source embedded with the field source, provided by wired means, provided by wireless means, and provided by combinations of these.

The signal can cause the positioning sub-system to act via a signal processor. The signal processor can be part of the sensor, can be part of the positioning sub-system, can be independent of the sensor and the positioning subsystem, and can be combinations of these.

The positioning sub-system can act on the target volume directly, can act on a body containing the target volume, and can act on combinations of these.

The positioning sub-system can be caused to act by the signal by wired means, by wireless means, and by combinations of these.

The positioning subsystem can be a positioning system which is normally present in the environment where the product is used. For example, in a radiation oncology case, the positioning sub-system can be an existing positioning couch already in use with the radiation beam, and can be a modification of this.

The positioning sub-system can use various means known in the art—such as mechanical means, electrical means, pneumatic means, and combinations of these—can use unforeseeable means, and can use combinations of these.

With existing field configuration means and existing sensors, motions of a fraction of a millimeter in one hundredth of a second can be measured. Both sensor art and electromagnetic properties of materials art are rapidly evolving so that unforeseeable new means may appear.

Various forms of the position control product can be used—including unforeseeable forms—so long as, at least in one form, a sensor detects changes in an electromagnetic field representing motions of target coordinates relative to reference coordinates of at least a millimeter and outputs a signal which causes a positioning sub-system to cause at least linear compensating motion in order to maintain a preplanned fixed relationship between at least one target coordinate and at least one reference coordinate.

One form of the product provides tracking in three dimensions and compensates repeatedly, or even continuously, in real time to maintain a preplanned fixed relationship between at least one target coordinate and at least one reference coordinate to provide real-time positioning and/or motion compensation data during use of the radiation beam or other product.

The number of electromagnetic field sources and sensors need not be the same and the sensors can be capable of measuring magnitudes and/or gradient along a known direction. In some applications, it can be advantageous to have a larger number of electromagnetic field sources than the number of sensors, or vice versa. In one form, some sensors can be dedicated to monitoring stray fields from the local equipment or the long lower gradient fields (from the earth) where the position control product is used so that such stray fields can either be removed, or accounted for, in determining the movements of the positioning sub-system 31.

In other words, modulating some of the external elements, such as certain sensors, can be used to source geometries or source strengths to remove or refine possible ambiguities in determining the movement of the positioning sub-system 31.

In one form, the source position can be modulated with respect to the sensors. Depending on the location of the sensors, the sensor's position or orientation can even be modulated with respect to the sources. For example, a device could be fixed near the target volume 71 with small Spintronic sensors spinning or oscillating at 100 cps over known paths and in various planes/directions in order to obtain data with respect to a given array of implanted permanent dipole magnets supplying known vector fields with respect to there own axes.

In one form, the positioning sub-system (such as a robotic arm) moves a device acting on the target volume, such as one emitting a radiating beam, instead of moving the target volume 71, in order to keep the first target coordinate in a preplanned relationship with the first reference coordinate.

Claimed is:

1. A position control product wherein a positioning controller is used with a positioning sub-system, the positioning sub-system in use keeping a target volume in a preplanned position, the positioning controller comprising:
an electromagnetic field;
an electromagnetic field sensor,
a signal,
the signal being output by the sensor,
the signal representing a change in the field measured by the sensor,
the change in the field representing at least a first linear motion of at least a first target coordinate relative to at least a first fixed reference coordinate,
the signal causing the positioning sub-system to cause at least a first linear counteracting motion in order to keep the first target coordinate within at least one millimeter of at least a first fixed preplanned relationship with the first reference coordinate.

2. The product of claim 1 wherein the sensor has a known sensor relationship with the first target coordinate and the field has a known field relationship with the first reference coordinate.

3. The product of claim 1 wherein the sensor has a known sensor relationship with the first reference coordinate and the field has a known field relationship with the first target coordinate.

4. The product of claim 1 wherein the field is modulated.

5. The product of claim 1 wherein the sensor can detect a sensor triad of orthogonal linear motions and can detect a sensor triad of orthogonal rotations, and wherein the signal can cause the positioning sub-system to cause a positioning triad of orthogonal counteracting linear motions and can cause a positioning triad of orthogonal counteracting rotations.

6. The product of claim 1 where the field is caused by a magnet.

7. The product of claim 1 wherein the field is caused by a transmitter.

8. The product of claim 1 wherein the field has field source components.

9. The product of claim 1 wherein the sensor has sensor components.

10. The product of claim 1 wherein the change in the field representing at least a first linear motion of at least a first target coordinate by at least five millimeters relative to at least a first fixed reference coordinate.

11. A position control product wherein a positioning controller is used with a positioning sub-system, the positioning sub-system in use keeping a target volume and a device acting on the target volume in a preplanned position with respect to one another, the positioning controller comprising:
an electromagnetic field;
an electromagnetic field sensor,
a signal,
the signal being output by the sensor,
the signal representing a change in the field measured by the sensor,
the change in the field representing at least a first linear motion of at least a first target coordinate, related to the target volume, relative to at least a first reference coordinate, related to the device,
the signal causing the positioning sub-system to cause at least a first linear counteracting motion of at least one of the target volume and the device acting on the target volume in order to keep the first target coordinate in a first preplanned relationship with the first reference coordinate.

12. The product of claim 11 wherein the sensor has a known sensor relationship with the first target coordinate and the field has a known field relationship with the first reference coordinate.

13. The product of claim 11 wherein the sensor has a known sensor relationship with the first reference coordinate and the field has a known field relationship with the first target coordinate.

14. The product of claim 11 wherein the field is modulated.

15. The product of claim 11 wherein the sensor can detect a sensor triad of orthogonal linear motions and can detect a sensor triad of orthogonal rotations, and wherein the signal can cause the positioning sub-system to cause a positioning triad of orthogonal counteracting linear motions and can cause a positioning triad of orthogonal counteracting rotations.

16. The product of claim 11 where the field is caused by a magnet.

17. The product of claim 11 wherein the field is caused by a transmitter.

18. The product of claim 11 wherein the field has field source components.

19. The product of claim 11 wherein the sensor has sensor components.

20. The product of claim 11 wherein the change in the field representing at least a first linear motion of at least a first target coordinate by at least five millimeters relative to at least a first fixed reference coordinate.
